(19) United States
(12) Patent Application Publication
(10) Pub. No.: US 2007/0273890 A1
(43) Pub. Date: Nov. 29, 2007

(54) Method and Device for Measuring Coarseness of a Paint Film

(76) Inventor: Swie Lan Njo, Oegstgeest (NL)

Correspondence Address: KENYON & KENYON LLP, ONE BROADWAY, NEW YORK, NY, 10004, US

(21) Appl. No.: 11/793,486

(22) PCT Filed: Dec. 13, 2005
(86) PCT No.: PCT/EP05/56761

§ 371 Date: Jun. 28, 2007

Related U.S. Application Data
(60) Provisional application No. 60/654,478, filed on Feb. 22, 2005.

(30) Foreign Application Priority Data
Dec. 14, 2004 (EP) 04078383.9

(51) Int. Cl. G01B 11/30

(52) U.S. Cl. 356/600

(57) ABSTRACT

A method for analyzing the visual coarseness of a paint film comprising effect pigments by means of a measuring device having a cavity with reflective inner walls and a sample opening, the device further comprising illumination means for illumination of the cavity and a digital imaging device directed from the cavity to the sample opening and arranged at a distance from the centre normal of the sample opening, the method comprising the following steps: presenting a sample of the paint film to the cavity via the sample opening; illuminating the cavity; activating the imaging device to record an image of the sample; communicating the recorded image data to a computer programmed with image analysis software to analyze the recorded image. The optical axis of the imaging device is set at an angle of 3-12 degrees with the centre normal of the sample opening.

### REFERENCE TO RELATED APPLICATION(s)

This application claims the benefit of U.S. Provisional Application No. 60/654,478 filed on Feb. 22, 2005.

### FIELD OF INVENTION

The invention relates to a method and a device for analyzing the visual coarseness of a paint film comprising effect pigments by means of a measuring device having a cavity with reflective inner walls and a sample opening, the device further comprising illumination means for illumination of the cavity and a digital imaging device directed from the cavity to the sample opening and arranged at a distance from the centre normal of the sample opening, wherein the imaging device is activated to record a digital image file of a sample of a paint film presented via the sample opening.

### BACKGROUND OF INVENTION

Particularly when effect pigments such as aluminum flake pigments are used, the look of a paint film is not of a uniform colour, but shows texture. This can include phenomena such as coarseness, glints, micro-brilliance, cloudiness, mottle, speckle, sparkle or glitter. In the following, texture is defined as the visible surface structure in the plane of the paint film depending on the size and organization of small constituent parts of the surface material. Coarseness is texture without the effects of glints and glitter. Hence, coarseness can be defined as the surface structure visible under the condition of diffuse light in the plane of the paint film depending on the size and organization of small constituent parts of the surface material. When light comes from each direction to the same extent, it is considered to be diffuse. Since glitters and glints are variations in gloss which are dependent on the angle between the observation direction and the illumination direction, glitters and glints do not occur under the condition of diffuse light.

In this context, texture and coarseness do not include roughness of the paint film but only the visual irregularities in the plane of the paint film. Where “colour” refers to reflection of light by structures smaller than the resolution of the human eye, reflection of light by larger structures appears as texture.

Car paints often comprise effect pigments such as aluminium flake pigments to give a metallic effect. Also pearlescent flake pigments are used. The use of such pigments results in a certain degree of texture and coarseness, depending on a number of parameters, such as the particle size distribution of the effect pigments and the colour contrast with the other pigments. When a damaged car needs to be repaired, a repair paint must be used which not only has a matching colour but which also matches in terms of other visual characteristics such as texture and coarseness.

Hitherto, the texture and the coarseness of surfaces, in particular paint films, have been judged by the eye, e.g., by comparing them with samples in a sample fan. The results of such an approach are highly dependent on the skills of the practitioner and often are not satisfying.

US patent application US 2001/0036309 discloses a method of measuring micro-brilliance and using it for matching a repair paint with an original paint on, e.g., an automobile. The micro-brilliance is measured by imaging a part of the paint film with a CCD camera and by using image processing software to calculate micro-brilliance parameters. The effect of gonio-dependent effects such as glitters and glints is not eliminated.

WO 03/029766 discloses a colour measuring device, e.g. for paints, comprising an enclosure for receiving the object to be measured, lamps, and a digital camera. The inner surface of the enclosure can be coated with a matt paint to obtain diffused and uniform light. It further describes a method of measuring texture in such an enclosure and calculating a texture value. The lamps as well as the camera and the object to be measured are located in the enclosure. Due to this arrangement, glitters and glints still occur, and therefore diffuseness of light cannot be optimized this way nor coarseness effectively measured.

WO 99/042900 discloses a method and a device for imaging an object placed in an internally illuminated white-walled integrating sphere using a digital camera. The image is analyzed by a computer to generate colour data. The optical axis of the camera is aligned with the object to be measured.

### SUMMARY OF INVENTION

It is the object of the invention to provide a device and a method which allow analysis and characterization of visual coarseness without the effect of glints or glitters.

The object of the invention is achieved with a method for analyzing the visual coarseness of a paint film comprising effect pigments by means of a measuring device having a cavity with reflective inner walls and a sample opening, the device further comprising illumination means for illumination of the cavity, and a digital imaging device directed from the cavity to the sample opening and arranged at a distance from the centre normal of the sample opening, the method comprising the following steps:
presenting a sample of the paint film to the cavity via the sample opening;
illuminating the cavity;
activating the imaging device to record an image of the sample; communicating the recorded image data to a data processing unit programmed with image analysis software to analyze the recorded image and to calculate a coarseness value based on the differences between the reflection data per pixel.

### BRIEF DESCRIPTION OF DRAWINGS

FIG. 1 shows a cross-section of an embodiment of the device according to the present invention.

### DETAILED DESCRIPTION

The centre normal of the sample opening is the virtual line at right angles with the sample opening crossing the sample opening at its centre point.

Self-reflection of the camera can effectively be prevented if the optical axis of the imaging device is set at an angle of at least 3 degrees with the centre normal of the sample opening, preferably at an angle of at least 6 degrees. If the angle is too large, the problem may arise that the camera is not at a sufficiently equal distance from every point of the sample. This can result in distortions of the recording. To prevent this, the angle with the centre normal through the sample opening can, e.g., be kept below about 13 degrees, for instance below 10 degrees. However, larger upper limits for this angle may also be used, if so desired. In that case, distortions of the recording can for example be corrected during processing of the recorded data.

Direct illumination of the sample by the illumination means would disturb the diffuse light conditions and can for example be prevented by locating the opening for the illumination means at a distance from the sample opening of a about a quarter of the outline of the cavity, or less.

To close off the sample opening during activation of the imaging device, a sample can be used which is larger than the sample opening. Alternatively, the sample can for example be placed on a panel which closes off the sample opening.

The device used according to the invention for analyzing the optical properties of a product surface has a cavity with reflective inner walls and a sample opening, and further comprises illumination means for illumination of the cavity and a digital imaging device directed from the cavity to the sample opening and arranged at a distance from the centre normal of the sample opening. Diffusion of the light from the illumination source is optimized if the openings together do not take up more than 9%, preferably 5% or less, of the inner surface of the cavity. Also the shape of the cavity influences the extent of light diffusion. In this respect, spherical cavities give the best results. The reflectivity of the inner wall can be obtained by painting it white.

The digital imaging device can for example be a video or photocamera, e.g., a CCD camera.

Using image processing techniques, the image is analyzed using parameters such as the contrast between pattern and background and the structure of the pattern in the case of diffuse coarseness, and subsequently characterized by a scalar number, according to a scale, every incremental step of the scale corresponding to an equal incremental step of diffuse coarseness as experienced by a human observer.

Coarseness data can be distracted from the digital recording using, e.g., statistical methods, filter-bank methods, structural methods and/or model based methods.

A suitable way to calculate coarseness is as follows. A CCD image is built up of a large matrix of pixels. To calculate coarseness, the gray value standard deviation at several scales is determined. At the smallest scale it is calculated over all individual pixels. At the second smallest scale it is calculated over the average gray values of squares of 4 pixels. At the third smallest scale squares of 16 pixels are used. This is scaled up until a scale is reached where all CCD pixels are covered.

The gray value standard deviation can be described as function of the scale, using:

$$GVSTD = A + \frac{B}{{X}^{C}}$$

with A, B, and C representing fit parameters and X the scale and GVSTD the gray value standard deviation. It can be correlated to the visual coarseness value by:
Coarseness=α₁+α₂A+α₃B+α₄C

The parameters α₁, α₂, α₃ and α₄ are found by minimizing Σ_{all panels} (average visual judgment_{panel i}−Coarseness_{panel i})² using the set of representative car colours. When α₁, α₂, α₃ and α₄ are known, the coarseness of any colour can be determined.

In an alternative way to calculate coarseness, the mean gray value (m) and the standard deviation (σ) are determined of all pixels of the image. Coarseness is then expressed as follows:

$$Coarseness = {α}_{1} + {α}_{2} \frac{σ}{m}$$

The parameters α₁ and α₂ are found by minimizing Σ_{all panels} (average visual judgment_{panel i}−Coarseness_{panel i})² using the set of representative car colours. When α₁ and α₂ are known, the coarseness of any colour can be determined. Instead of gray values, the R, G and/or B values can also be used.

In a structural method to calculate coarseness, the image is segmented in subsets of neighbouring pixels that stand out. A threshold is defined, 10 times the mean value (m) of the image, to distinguish segments from the background. Segments can have a maximum size of 2.5% of the total amount of pixels in the image and should be 8-connected. Also other segmentation method might be used. The number of segments (n) is calculated and the mean value of a segment (ms). The coarseness is then calculated as follows:
Coarseness=α₁+α₂ln n+α₃ ln ms+α₄ ln m

As above, the parameters α₁, α₂, α₃ and α₄ are found by minimizing Σ_{all panels} (average visual judgment_{panel i}−Coarseness_{panel i})² using the set of representative car colours. When α₁, α₂, α₃ and α₄ are known, the coarseness of any colour can be determined.

The effect of coarseness is mainly caused by the larger optical non-uniformities. Smaller non-uniformities hardly contribute to coarseness. A filter-bank method can be used to filter out the smaller non-uniformities. To this end, the image is first transformed to the Fourier domain. Then a filter is applied to select and filter out certain frequency areas. Subsequently, the image is backtransformed and the mean value (m) and standard deviation (σ) are extracted. As above, the coarseness is calculated as follows:

$$Coarseness = {α}_{1} + {α}_{2} \frac{σ}{m}$$

The parameters α₁ and α₂ are found by minimizing Σ_{all panels} (average visual judgment_{panel i}−Coarseness_{panel i})² using the set of representative car colours. When α₁ and α₂ are known, the coarseness of any colour can be determined.

The invention is particularly useful in examining automotive paints and in finding matching repair paints, e.g., for cars or other products to be repaired. Car paints often comprise effect pigments such as aluminium flake pigments to give a metallic effect. Also pearlescent flake pigments are used. The use of such pigments results in a certain degree of texture and coarseness, depending on a number of parameters, such as the particle size distribution of the effect pigments and the colour contrast with the other pigments. When a damaged car needs to be repaired, a repair paint must be used which not only has a matching colour but which also matches in terms of other visual characteristics such as texture and coarseness.

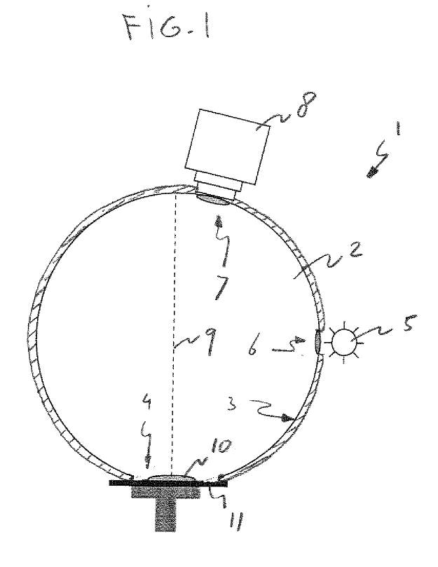

The invention will further be explained by means of the drawings in FIG. 1, showing in cross-section a device according to the present invention. FIG. 1 shows a measuring device 1 according to the present invention having a-cavity 2 with a reflective inner wall 3 and a sample opening 4. A light source 5 illuminates the cavity 2 via a light source opening 6. Via a third opening 7, a digital camera 8 is directed to the sample opening 4. The digital camera 8 is arranged at a distance from the centre normal 9 of the sample opening 4. The optical axis of the camera 8 is set at an angle of 8 degrees with the centre normal of the sample opening. In FIG. 1, a sample 10, e.g., of a substrate coated with a paint film comprising effect pigments, is presented to the cavity 2 via the sample opening 4. The sample is placed on a panel 11 which closes off the sample opening 4. The light source opening 6 is located in the cavity wall 3, about halfway between the camera opening 7 and the sample opening 4.

The cavity 2 is illuminated and the camera 8 is activated to record an image of the sample 10. Via a data transfer cable, the recording is communicated to a computer programmed with image analysis software to analyze the recorded image. Alternatively or additionally, the data can also be processed in a data processing unit within the camera.

1-10. (canceled)

11. A device for analyzing the optical properties of a sample surface, the device comprising:
a cavity with a reflective inner wall and a sample opening;
an illumination means for illumination of the cavity;
a digital imaging device directed from the cavity to the sample opening, and arranged at a distance from the centre normal of the sample opening, wherein the digital imaging device can be activated to record a digital image file of a sample presented via the sample opening, the digital image file comprising reflection data per pixel; and
a data processing unit programmed to calculate a coarseness value based on the differences between the reflection data per pixel.

12. The device according to claim 11, wherein the sample opening takes up less than 9% of the reflective inner wall of the cavity.

13. The device according to claim 11, wherein an optical axis of the digital imaging device is at an angle of 3 to 12 degrees with the centre normal of the sample opening.

14. The device according to claim 12, wherein an optical axis of the digital imaging device is at an angle of 3 to 12 degrees with the centre normal of the sample opening.

15. The device according to claim 11, wherein the cavity is spherical.

16. The device according to claim 12, wherein the cavity is spherical.

17. The device according to claim 14, wherein the cavity is spherical.

18. The device according to claim 11, wherein the reflective inner wall of the cavity is white.

19. The device according to claim 13, wherein the reflective inner wall of the cavity is white.

20. The device according to claim 17, wherein the reflective inner wall of the cavity is white.

21. The device according to claim 11, wherein the digital imaging device is a CCD camera.

22. The device according to claim 13, wherein the digital imaging device is a CCD camera.

23. The device according to claim 20, wherein the digital imaging device is a CCD camera.

24. A method for analyzing the visual coarseness of a sample, the method comprising:
presenting a sample to a measuring device, the measuring device comprising a cavity with a reflective inner wall and a sample opening, an illumination means for illumination of the cavity, and a digital imaging device directed from the cavity to the sample opening and arranged at a distance from the centre normal of the sample opening, wherein the sample is presented to the cavity via the sample opening;
illuminating the cavity with the illumination means;
activating the digital imaging device to record a digital image file of the sample, wherein the digital image file includes reflection data per pixel; and
communicating the digital image file to a data processing unit programmed to calculate a coarseness value based on the differences between the reflection data per pixel.

25. The method according to claim 24, wherein the sample includes a paint film comprising effect pigments.

26. The method according to claim 25, wherein the coarseness value is calculated using a model that correlates a calculated value to a value as determined by visual judgment using a least square method.

27. The method according to claim 25, wherein an optical axis of the digital imaging device is at an angle of 3 to 12 degrees with the centre normal of the sample opening.

28. The method according to claim 26, wherein an optical axis of the digital imaging device is at an angle of 3 to 12 degrees with the centre normal of the sample opening.

29. The method according to claim 25, wherein the sample is larger than the sample opening, and during activating of the digital imaging device the sample closes off the sample opening.

30. The method according to claim 28, wherein the sample is larger than the sample opening, and during activating of the digital imaging device the sample closes off the sample opening.
